(19) United States
(12) Patent Application Publication
(10) Pub. No.: US 2005/0071199 A1
(43) Pub. Date: Mar. 31, 2005

(54) Aggregating patient information for use in medical device programming

(76) Inventor: Kenneth M. Riff, Kamuela, HI (US)

Correspondence Address: MEDTRONIC, INC., 710 MEDTRONIC PARKWAY NE, MS-LC340, MINNEAPOLIS, MN, 55432-5604, US

(21) Appl. No.: 10/675,691

(22) Filed: Sep. 30, 2003

(51) Int. Cl. G06F 17/60

(52) U.S. Cl. 705/3

(57) ABSTRACT

Techniques are described for incorporating patient medical information of a clinical information system in programming decision making to improve programming parameter selection. In particular, a medical device programmer accesses patient medical information of the clinical information system and provides an interface by which a programming operator interacts with the medical device programmer to identify a programming parameter value based on the patient medical information. The medical device programmer either computes programming parameter values and suggests the computed programming parameter values to the programming operator or displays the patient medical information to the programming operator who considers it in determining programming parameter values. The medical device programmer may also update the clinical information system with either clinical or administrative data, which may then be acted upon by the clinical information system.

### TECHNICAL FIELD

The invention relates to medical devices and, more particularly, programming of medical devices.

### BACKGROUND

A programmable medical device is used to administer and deliver a therapy to a patient. Further, the medical device may also be configured to monitor a physiological condition of the patient. The medical device is either an implantable medical device that is implanted in the patient or an external medical device that is carried or worn by the patient. One exemplary medical device is an implantable cardiac device, such as an implantable pacemaker, an implantable cardioverter/defibrillator (ICD), or an implantable pacemaker/cardioverter/defibrillator (PCD). An implantable cardiac device, for example, delivers pacing pulses or shocks to a heart of the patient in order to produce a steady heart rhythm. Examples of other medical devices that administer and deliver therapies to the patient include neurostimulation devices, drug delivery devices, and the like.

Many medical devices require programming of various parameters to assure safe and effective operation. For example, a medical device occasionally needs to be reprogrammed due to variations in the patient's condition or changes in the operation of the device over a period of time. Generally, programming of the medical device is performed in a clinical setting with a dedicated stand-alone programmer supplied by a medical device manufacturer. A human operator, such as a clinician, manually controls the programmer to adjust the operating parameters of the medical device. In particular, the programmer receives instructions for the programming session from the human operator through direct manual intervention. For example, the human operator manipulates a control device, e.g., a peripheral pointing device, a keyboard, or a touch screen display, that controls programming commands sent to the medical device.

Selecting appropriate operating parameters for the medical device depends on a number of factors, including the patient's overall health status, current medications, and other patient medical information as well as data collected by the medical device itself, e.g., effectiveness of current operating parameters. In order to be knowledgeable regarding all of the factors that can impact selection of appropriate operating parameters, the human operator must locate the information pertaining to each of the factors. For example, to determine what medications the patient is currently taking, the operator typically must access patient records that contain the patient's medication list. Similarly, the operator accesses a separate source of laboratory data to determine the results of laboratory tests that may impact device programming.

Accordingly, there is a need to collect and coherently aggregate patient information for use in medical device programming.

### SUMMARY

In general, the invention is directed to programming of a medical device. More specifically, a programmer incorporates patient medical information from a clinical information system to improve programming parameter selection. The clinical information system frequently includes patient medical information, such as medication lists, past medical history, laboratory test results, radiology results, and the like, that are important in making programming decisions.

The programmer accesses patient medical information within a clinical information system and considers the patient medical information when making or recommending programming decisions. For example, in some cases, the programmer considers the patient medical information in determining recommended values of programming parameters of a medical device.

In accordance with the invention, the programmer is able to directly access the patient medical information to aid in the selection of programming parameter values. For example, a medical device programmer automatically retrieves and presents patient medical information to the programming operator. In addition, in some embodiments, the medical device programmer, or associated computing hardware, is configured to compute recommended programming parameter values based on the patient medical information obtained from the clinical information system.

Hence, the human programming operator makes use of the patient medical information in addition to operational information and sensed physiological parameters extracted from the medical device. The medical device programmer displays the recommended or suggested programming parameter values to a programming operator, who either selects the suggested programming parameter values or overrides the suggestion by manually inputting programming parameter values.

Alternatively, the programmer indirectly uses the patient medical information in the selection of programming parameter values. For example, a medical device programmer displays relevant patient medical information to a programming operator, who considers the displayed patient medical information in making non-automated programming parameter selections. The invention can reduce the amount of research the programming operator must perform in order to account for other sources of patient medical information, and also ensures that relevant data is easily available to the programming operator, by allowing access to the patient medical information maintained in a clinical information system via the medical device programmer.

In one embodiment, the invention is directed to a method comprising accessing patient medical information of a clinical information system with a medical device programmer, providing an interface by which a programming operator interacts with the medical device programmer to identify a programming parameter value based on the patient medical information, and programming a medical device with the medical device programmer in accordance with the programming parameter value.

In another embodiment, the invention is directed to a system comprising a programmable medical device that delivers a therapy to a patient, a clinical information system that stores patient medical information, a medical device programmer that accesses patient medical information of the clinical information system and provides an interface by which a programming operator interacts with the medical device programmer to identify a programming parameter value based on the patient medical information.

In another embodiment, the invention is directed to a programming device comprising a medical information interface by which the programming device accesses patient medical information of a clinical information system and a user interface by which a programming operator interacts with the programming device to identify a programming parameter value based on the patient medical information.

In other embodiments, the invention is directed to computer-readable media comprising instructions to cause a processor to implement the techniques described herein.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating a system in which a programmer incorporates patient medical information of a clinical information system in programming decision making to improve programming parameter selection.

FIG. 2 is a block diagram illustrating a programming system that incorporates patient medical information from at least a portion of clinical information systems in programming decision making.

FIG. 3 is a block diagram illustrating another programming system that incorporates patient medical information from at least a portion of clinical information systems in programming decision making.

FIG. 4 is a block diagram illustrating an exemplary clinician programmer in accordance with the invention.

FIG. 5 is a flow diagram illustrating operation of a programming system in which a programmer incorporates patient medical information of a clinical information system in programming decision making.

FIG. 6 is a flow diagram illustrating exemplary operation of a programming system that incorporates patient medical information of a clinical information system in automatically computing programming parameter values for a medical device.

### DETAILED DESCRIPTION

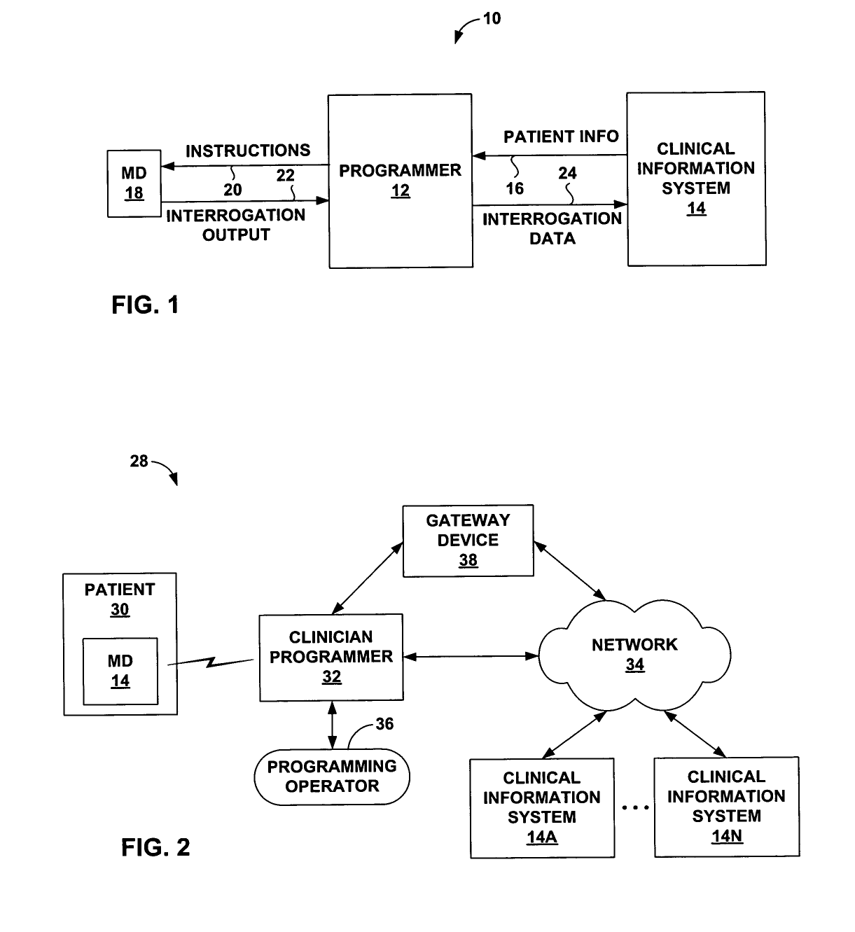

FIG. 1 is a block diagram illustrating a system 10 in which a programmer 12 incorporates patient medical information of a clinical information system 14 in programming decision making to improve programming parameter selection. Clinical information system 14 includes information that is important in making programming decisions, such as medication lists, past medical history, laboratory test results, radiology results, and the like. Programmer 12 accesses patient medical information of clinical information system 14, as indicated by line 16, to improve programming parameter selection. In other words, programmer 12 facilitates consideration of the patient medical information in determining values of programming parameters of a medical device (MD) 18.

In some embodiments, programmer 12 directly uses the patient medical information in the automated selection of programming parameter values. For example, a medical device programmer within programmer 12 automatically computes suggested programming parameter values based on the patient medical information of clinical information system 14 in addition to operational information and sensed physiological parameters extracted from medical device 18. The medical device programmer displays the suggested programming parameter values to a programming operator, who either selects the suggested programming parameter values or overrides the suggestion by manually inputting programming parameter values.

Alternatively, programmer 12 indirectly uses the patient medical information in the selection of programming parameter values. For example, a medical device programmer within programmer 12 retrieves and displays, or otherwise presents, relevant patient medical information from clinical information system 14 to a programming operator, who considers the displayed patient medical information in making programming parameter selection. The techniques of the invention reduce the amount of research or other searching for information that programmer 12 must perform in order to account for other resources of patient medical information by accessing the patient medical information of clinical information system 14 via the medical device programmer.

Programmer 12 initiates a programming session with medical device 18 upon selection of the programming parameter values. Specifically, programmer 12 communicates a set of instructions to medical device 18 to reprogram one or more operating parameters of medical device 18, as indicated by line 20. In some embodiments, the set of instructions are communicated via one or more intermediate devices. For example, in some embodiments, a clinician interacts with a medical device programmer to relay the set of instructions to a remote medical device programmer, which initiates the programming session with medical device 18.

Programmer 12 also interrogates medical device 18 to extract interrogation output, indicated by line 22, from medical device 18. The interrogation output extracted from medical device 18 includes operational information and sensed physiological parameters, e.g., sensed cardiac events, therapeutic events, and the like. Programmer 12 either interrogates medical device 18 in a clinical setting, e.g., during a follow-up appointment, or remotely via a patient monitoring device located at a remote location, e.g., in a patient's home. The interrogation data extracted from medical device 18 is exported to and stored within clinical information system 14, as indicated by line 24. In this manner, programmer 12 exports information to clinical information system 14 and imports information from clinical information system 14 to facilitate record-keeping and clinical efficiency, as well as improve the quality of care provided to the patients.

Programmer 12 includes one or more medical device programmers operated by one or more human programming operators. For example, programmer 12 includes a clinician medical device programmer, a programming controller, a remote medical device programmer, or a handheld medical device programmer operated by a clinician, a programming technician, follow-up nurse or a combination thereof. Medical device 18 is any programmable medical device including an implantable medical device as well as an external medical device. For example, medical device 18 may comprise an implantable cardiac device such as a pacemaker, an implantable cardioverter/defibrillator (ICD), or implantable pacemaker/cardioverter/defibrillator (PCD), a neurostimulation device, a drug delivery device, e.g., an insulin pump, or any other programmable medical device. Clinical information system 14 includes, for example, a Healthcare Information System (HIS), an Electronic Medical Records (EMR) system, a Practice Management System (PMS), a cardiovascular information system, a clinical laboratory information system, a Picture Archiving and Communication System (PACS), or other medical information system that stores relevant patient information.

The programming session established between programmer 12 and medical device 18 is either a remote programming session or an in-clinic programming session. In general, the term “remote programming session” refers to a programming session that takes place without the physical presence of the clinician initiating the programming session. For example, the clinician is at a medical clinic while the patient is at home. Alternatively, the clinician is away from the medical clinic, but still participate in the programming session via a network client device. In another example, the patient is in a satellite medical clinic while the clinician initiating the programming session is in a primary medical clinic. As a further example, the patient is one of many patients within a clinic or hospital. In each case, remote programming involves initiation of a programming session outside of the direct presence of a clinician or other medical personnel responsible for programming, and is accomplished by a telecommunication link, either wired, wireless or a combination of both.

FIG. 2 is a block diagram illustrating a programming system 28 that incorporates patient medical information from at least a portion of clinical information systems 14A-14N (“14”) in programming decision making to improve programming parameter selection. As described, clinical information systems 14 frequently contain patient medical information that is important in making programming decisions.

Programming system 28 includes a clinician medical device programmer 32, referred to herein as clinician programmer 32, that is coupled to clinical information systems 14 via a network 34. Network 34 can be a combination of network architectures, including a local area network (LAN), a wide area network (WAN), a wireless LAN (WLAN), a public network, such as the Internet, or a combination thereof. Clinician programmer 32 accesses patient medical information of at least a portion of clinical information systems 14 to influence programming parameter selection of parameters of medical device 18. For example, clinician programmer 32 accesses medication lists, past medical history information, laboratory test results, radiology test results, and the like to provide additional information to aid in programming decisions.

In one embodiment of the invention, clinician programmer 32 includes a parameter computing unit that computes programming parameter values based on the patient medical information of clinical information systems 14 and suggests the computed programming parameter values to a programming operator 36. Specifically, the parameter computing unit identifies relevant patient medical information for making programming decisions and compute programming parameter values to suggest to programming operator 36 based on the identified patient medical information. In this manner, clinician programmer 32 filters the patient medical information to obtain only patient medical information that is pertinent in making more accurate programming decisions.

In one example, clinician programmer 32 accesses a medication list of a pharmacy information system for a patient and automatically computes and suggests a higher defibrillation energy level due to the medication list. In particular, if the medication list indicates that patient 30 is currently taking amiodarone, an anti-arrhythmic drug known to increase defibrillation thresholds, clinician programmer automatically recommends an increased defibrillation energy level.

As another example, clinician programmer 32 accesses laboratory test results within a clinical information system 14, and identifies a recent abnormal blood chemistry reading suggesting that the pacing threshold has risen due to an electrolyte disturbance. In this case, clinician programmer 32 automatically recommends an increased pacing output voltage. As a further example, clinician programmer 32 accesses medical history information within a clinical information system 15, and determines that the patient has been diagnosed as having active cardiac ischemia. In this case, clinician programmer 32 automatically recommends reducing the upper pacing rate limit to prevent aggravating the ischemia.

Programming operator 36 views or otherwise is made aware of the programming parameter values suggested by clinician programmer 32, and either selects the suggested programming parameter values or overrides the suggested programming parameter values by manually inputting programming parameter values. Alternatively, clinician programmer 32 accesses patient medical information of clinical information systems 14 and displays the patient medical information to programming operator 36.

Programming operator 36 analyzes the patient medical information and determines appropriate programming parameter values for medical device 18 based on the patient medical information as well as operational information and sensed physiological parameters extracted from medical device 18. Clinician programmer 32 provides an interface by which programming operator 36 interacts to identify programming parameter values based on the aggregated information, e.g., patient medical information, operational information and sensed physiological parameters.

Specifically, programming operator 36 interacts with an input medium of clinician programmer 32 to input the programming parameter values for medical device 18. In this manner, the patient medical information of clinical information systems 14 is indirectly used in determining programming parameter values for medical device 15. For example, clinician programmer 32 displays a medical history of patient 30 to programming operator 36 indicating patient 30 has ischemic heart disease. Based on this information, programming operator 36 programs a reduced upper rate for an implantable pacemaker to avoid precipitating ischemia. The input medium is a keyboard, keypad, stylus, mouse, touch screen or the like.

In another embodiment, clinician programmer 32 accesses the patient medical information of clinic information systems 14 via a gateway device 38 that couples clinician programmer 32 to network 34 and clinical information systems 14. In particular, clinician programmer 32 accesses the patient medical information via gateway device 38 and provides an interface by which programming operator 36 interacts with clinician programmer 32 to identify programming parameter values based on the patient medical information.

As described above, clinician programmer 32 either computes programming parameter values and suggests the computed programming parameter values to programming operator 36 or displays the patient medical information to programming operator 36 who considers it in determining programming parameter values. Alternatively, gateway device 38 computes programming parameter values based on the patient medical information, which in turn are displayed to programming operator 36 via clinician programmer 32.

In either case, clinician programmer 32 initiates a programming session with medical device 18 of patient 30 upon identifying programming parameter values. Specifically, programming operator 36 interacts with clinician programmer 32 to identify programming parameter values in consideration of the patient medical information of clinical information systems 14 and sends instructions to medical device 18 via wireless telemetry techniques to update operating parameters of medical device 18.

Additionally, clinician programmer 32 interrogates medical device 18 to collect stored operational information and sensed physiological parameters. As described herein, the operational information and sensed physiological parameters are used in conjunction with the patient medical information of clinical information systems 14 in determining appropriate programming parameters. The acquired operational information and sensed physiological parameters from medical device 18 are relayed to and stored within at least one of clinical information systems 14. In this manner, clinical information systems 14 facilitate record-keeping and clinic efficiency by aggregating medical information from numerous sources. In some embodiments, clinician programmer 32 sends administrative data in addition to the acquired operational information and sensed physiological parameters. In one example, clinician programmer 32 receives input from programming operator 36 identifying administrative data and send instructions to a Practice Management system to automatically generate a bill, schedule a subsequent appointment, or other similar management action in accordance with the administrative data.

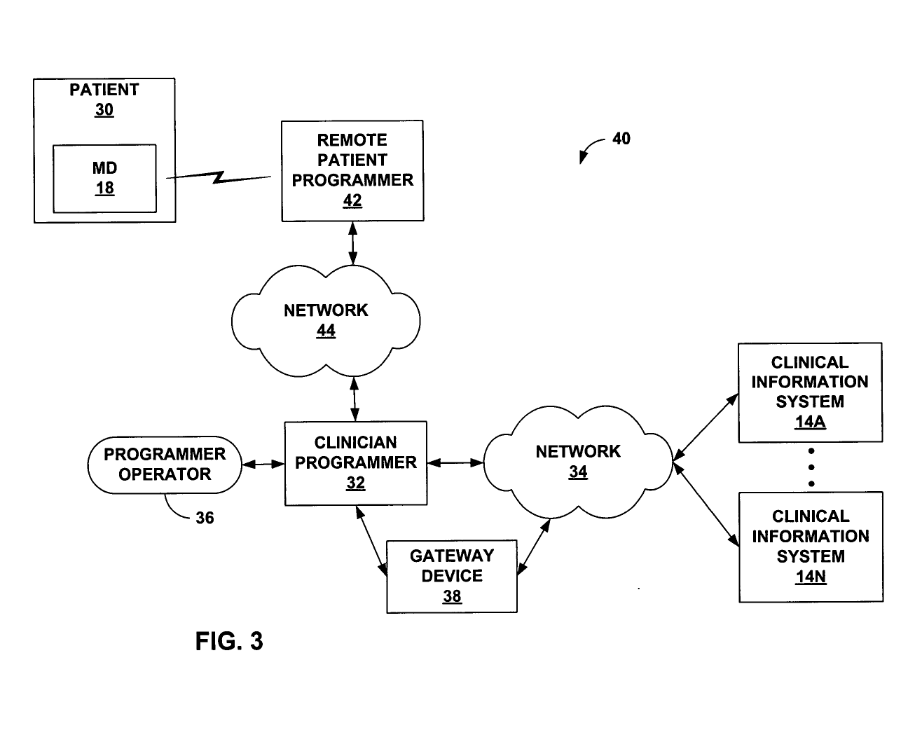

FIG. 3 is a block diagram illustrating another programming system 40 that incorporates patient medical information from at least a portion of clinical information systems 14A-14N (“14”) in programming decision making to improve programming parameter selection. Programming system 40 conforms substantially with programming system 28 of FIG. 2, but programming system 40 is configured for remote programming of medical device 18. As described above, remote programming refers to programming that takes place without the physical presence of the clinician initiating the programming session, e.g., the patient is located at home while a clinician is located at a medical clinic. In other words, clinician programmer device 32 transmits the programming instructions to medical device 18 via one or more intermediate devices.

Clinician programmer 32 transmits the programming instructions to a remote medical device programmer 42, referred to herein as remote programmer 42, via network 44. Network 44 is either a public telecommunications channel such as a telephone line or a network such as the Internet or a private network. Remote programmer 42, in turn, initiates a programming session with medical device 18 to reprogram operating parameters of medical device 18 in accordance with the programming parameters identified in accordance with the invention. In the case in which patient 30 is located at home and the clinician is located at the medical clinic, clinician programmer 32 relays the instructions to remote programmer 42 via a public network such as the Internet, a virtual private network (VPN), a public switched telephone network (PSTN), a mobile network or the like. In the case in which patient 30 is one of many patients within a clinic or hospital, clinician programmer 32 relays the instructions to remote programmer 42 via a clinical network, e.g., a local area network (LAN), wireless local area network (WLAN), or the like.

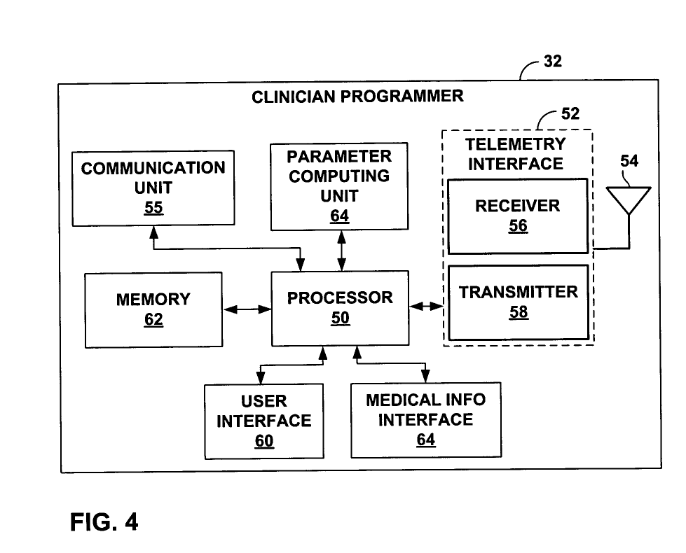

FIG. 4 is a block diagram illustrating an exemplary clinician programmer 32 in accordance with the invention. Clinician programmer 32 accesses patient medical information of a clinical information system 14 to improve programming parameter selection.

Clinician programmer 32 provides a user interface 60 by which programming operator 36, e.g., a clinician, interacts with clinician programmer 32 and medical device 18. In one example, user interface 60 is a graphical user interface (GUI) displayed on display monitor (not shown) of clinician programmer 32. Programming operator 36 interacts with user interface 60 via the display monitor and at least one input medium such as a keyboard, a peripheral pointing device, e.g., mouse, or a touch screen. A memory 62 stores program code that causes a processor 50 to drive user interface 60, and the functionality ascribed to user interface 60. Memory 62 includes any fixed or removable magnetic or optical media, such as RAM, ROM, CD-ROM, hard or floppy magnetic disks, EEPROM, or the like.

Clinician programmer 32 also includes a medical information interface 64 by which clinician programmer 32 provides access to patient medical information of clinical information systems 14. Clinician programmer 32 uses medical information interface 64 to either directly access the patient medical of clinical information systems 14 or access the patient information indirectly via a gateway device 38 (FIG. 2). Clinician programmer 32 displays the patient medical information to programming operator 36 via user interface 60, who in turn considers the patient medical information in determining programming parameter values.

In this manner, clinician programmer 32 indirectly uses the patient medical information in determining patient parameter values. Alternatively, clinician programmer 32 computes programming parameter values in consideration of the patient medical information and suggests the computed programming parameter values to programming operator 36 via user interface 60. For example, clinician programmer 32 includes a parameter computing unit 56 that takes into account the patient medical information from clinical information systems 14 in computing patient parameter values. Alternatively, processor 50 of clinician programmer 32 computes patient parameter values in view of the patient medical information.

As shown in FIG. 4, clinician programmer 32 further includes a processor 50, a wireless telemetry interface 52, an antenna 54, and a communication unit 55. Clinician programmer 32 is either in wireless communication with medical device 18 or in communication with remote programmer 42. In the latter case, clinician programmer 32 functions as a controller to control remote programmer 42 (FIG. 3). For example, clinician programmer 32 sends instructions to remote programmer 42 via communication unit 55 and a network. Remote programmer 42 initiates the programming session with medical device 18 to change one or more operating parameters of medical device 18 in accordance with the instruction from clinician programmer 32. Remote programmer 42 additionally interrogates medical device 18 to extract operational information and sensed physiological parameters acquired from medical device 18, and relays the information extracted from medical device 18 to clinician programmer 32 via communication unit 55. Communication unit 55 comprises a network card, a wireless local area network (WLAN) card, a mobile phone, an infrared (IR) card, a modem, or any combination thereof.

In the former case, clinician programmer 32 is in wireless communication with medical device 18, and transmits and receives signals to and from medical device 18 via telemetry interface 52 and antenna 54. Telemetry interface 52 includes a receiver 56 that receives data collected by medical device 18 and currently programmed parameters of medical device 18. Receiver 56 relays the collected data to processor 50 for processing. Telemetry interface 52 further includes a transmitter 58, which allows clinician programmer 32 to program medical device 18, e.g., to program new parameters values of medical device 18, via antenna 54. Although in the example illustrated in FIG. 4 telemetry interface 52 includes distinct components for receiving and transmitting signals, i.e., receiver 56 and transmitter 58, the telemetry interface can include a single transceiver component that includes receive circuitry as well as transmit circuitry.

Clinician programmer 32 relays the operational information and sensed physiological parameters acquired from medical device 18 to at least one of clinical information systems 14 for storage via communication unit 55. In this manner, clinical information systems 14 facilitate record-keeping and clinic efficiency by aggregating medical information from numerous sources. In some embodiments, clinician programmer 32 sends administrative data to clinical information systems 14 in addition to the acquired operational information and sensed physiological parameters. In one example, clinician programmer 32 receives input from programming operator 36 identifying the need for a subsequent appointment. Clinician programmer 32 sends instructions to a Practice Management system via communication unit 55 in order to automatically schedule a subsequent appointment for patient 12.

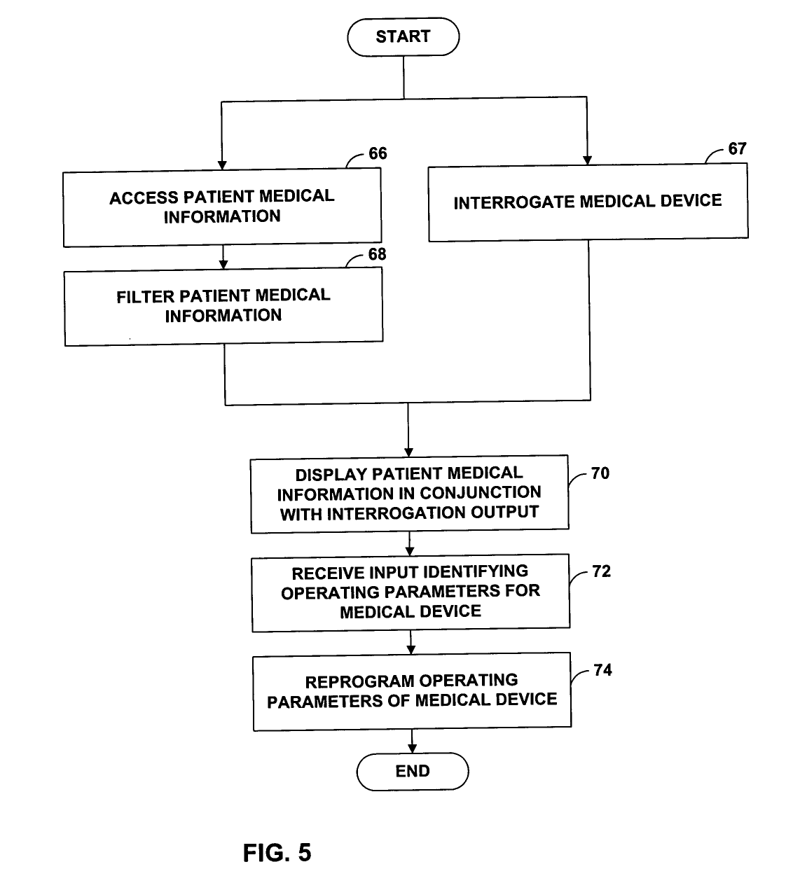

FIG. 5 is a flow diagram illustrating exemplary operation of a programming system in which a programmer 12 incorporates patient medical information of a clinical information system 14 in programming decision making to improve programming parameter selection. Initially, a clinician medical device programmer 32 accesses patient medical information stored in a clinical information system 14 (66). Clinician programmer 32 either accesses the patient medical information of clinical information system 14 directly or via a gateway device coupling clinician programmer 32 to clinical information system 14. Further, in some embodiments, clinician programmer 32 accesses patient medical information stored in a plurality of clinical information systems 14 simultaneously. Either concurrently or sequentially, clinician programmer 32 accesses data from the medical device via interrogation (67).

Clinician programmer 32 filters the patient medical information stored in clinical information system 14 in order to find patient medical information useful in making programming decisions (68). In this manner, clinician programmer 32 applies filtering criteria to patient medical information to narrow the vast quantities of patient medical information to the patient medical information pertinent to reprogramming of a particular medical device. Using reprogramming of a cardiac pacemaker as an example, clinician programmer 32 is configured to extract only medications that may affect the functions of the pacemaker from a patient medication list.

Clinician programmer 32 displays the patient medical information and the interrogated device data to programming operator 36 (70). For example, clinician programmer 32 displays the patient medical information to programming operator via user interface 60. Clinician programmer 32 receives input from programming operator 36 identifying values for one or more programming parameters based on the patient medical information as well as operational information and sensed physiological parameters extracted from medical device 18 (72). For example, if a laboratory result shows patient 30 has an abnormal electrolyte level, programming operator 36 identifies a changed pacing threshold based on the abnormal electrolyte level. In another example, programming operator 36 identifies an increased defibrillation energy threshold based on the prescription drugs currently taken by patient 30.

Clinician programmer 32 initiates a programming session with medical device 18 upon identifying the programming parameter values, thereby reprogramming the operating parameters of medical device 18 (74). The programming session initiated by clinician programmer 32 is either in a clinical setting or a remote programming session. In the latter case, clinician programmer 32 relays instructions to a remote medical device programmer, which initiates the programming session with medical device 18.

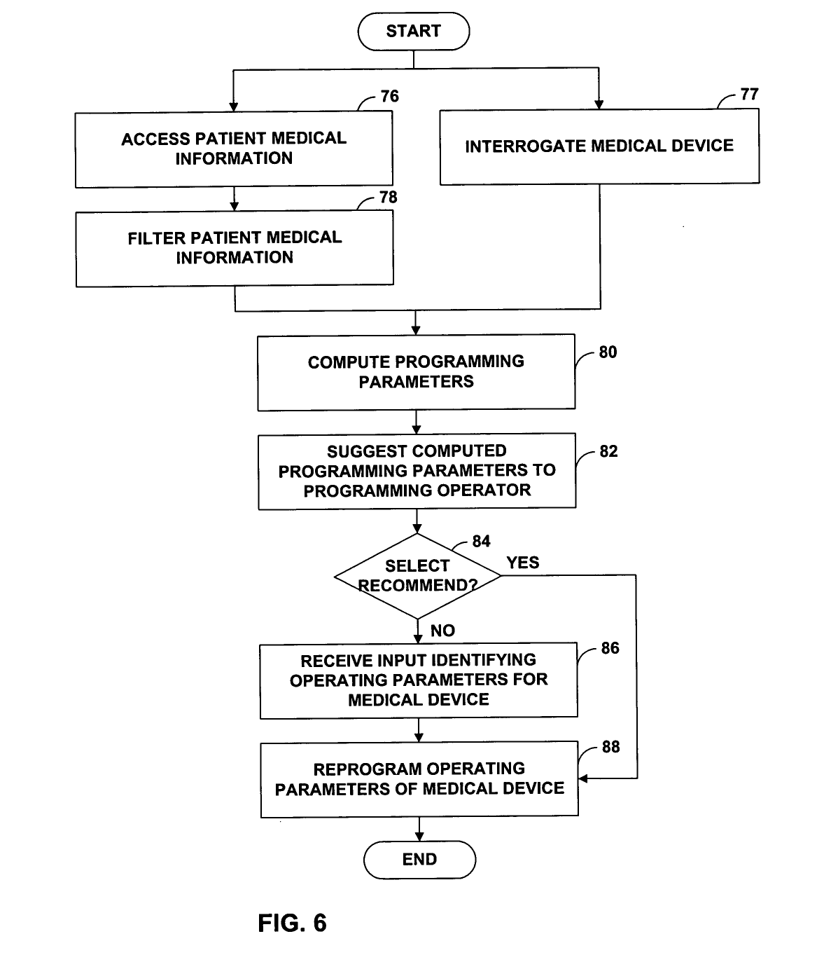

FIG. 6 is a flow diagram illustrating exemplary operation of a programming system that incorporates patient medical information of a clinical information system 14 in computing programming parameter values for a medical device 18. Initially, a clinician medical device programmer 32 accesses patient medical information stored in a clinical information system 14 (76) and also accesses data from the medical device via interrogation (77). Clinician programmer 32 either accesses the patient medical information of clinical information system 14 directly or via a gateway device coupling clinician programmer 32 to clinical information system 14. Clinician programmer 32 filters the patient medical information stored in clinical information system 14 in order to find patient medical information useful in making programming decisions (78).

Clinician programmer 32 computes one or more programming parameters in view of the patient medical information (80). In particular a parameter computing unit or a processor of clinician programmer 32 computes the programming parameters. In another embodiment, a gateway device 38 that couples clinician programmer 32 to clinical information system 14 computes the programming parameters based on the patient medical information. Clinician programmer 32 suggests the computed programming parameters to programming operator 36 via user interface 60 (82) and clinician programmer determines whether to select the suggested programming parameters (84).

If programming operator 36 does not accept the suggested programming parameters, programming operator 36 identifies values for one or more programming parameters based on the patient medical information as well as operational information and sensed physiological parameters extracted from medical device 18 (86) and initiates a programming session with medical device 18 to reprogram the operating parameters of medical device 18 (88). If programming operator 36 does accept the suggested programming parameters, clinician programmer initiates a programming session with medical device 18 to reprogram the operating parameters of medical device 18 (88).

The techniques described herein may be implemented in a combination of hardware, and software. Accordingly, certain aspects of the techniques described herein are partially or wholly executed in software. In that case, a computer readable medium stores or otherwise comprises computer readable instructions, i.e., program code that can be executed by a processor to carry out one of more of the techniques described above. For example, the computer readable medium comprises random access memory (RAM), read-only memory (ROM), non-volatile random access memory (NVRAM), electrically erasable programmable read-only memory (EEPROM), flash memory, or the like.

Various embodiments of the invention have been described. These and other embodiments are within the scope of the following claims.

1. A method comprising:
accessing patient medical information of a clinical information system with a medical device programmer;
providing an interface by which a programming operator interacts with the medical device programmer to identify a programming parameter value based on the patient medical information; and
programming a medical device with the medical device programmer in accordance with the programming parameter value.

2. The method of claim 1, wherein accessing the patient medical information comprises directly accessing the patient medical information of the clinical information system.

3. The method of claim 1, wherein accessing the patient medical information comprises accessing the patient medical information of the clinical information system via a gateway device that couples the clinical information system and the medical device programmer.

4. The method of claim 1, further comprising filtering the patient medical information to obtain a subset of the patient medical information from the clinical information system.

5. The method of claim 1, wherein accessing the patient medical information of the clinical information system comprises accessing the patient medical information of a plurality of clinical information systems.

6. The method of claim 1, further comprising presenting the patient medical information to the programming operator via the medical device programmer.

7. The method of claim 1, further comprising:
automatically computing a programming parameter value based on the patient medical information; and
displaying the computed programming parameter value to the programming operator via the medical device programmer.

8. The method of claim 7, wherein the programming operator identifies the programming parameter value by selecting the suggested programming parameter value.

9. The method of claim 1, further comprising initiating a programming session with the medical device to update at least one programming parameter value of the medical device based on the identified programming parameter value.

10. The method of claim 9, wherein initiating a programming session comprises initiating a remote programming session.

11. The method of claim 10, wherein initiating the programming session comprises sending instructions to an intermediary programming device via a network.

12. The method of claim 9, wherein initiating a programming session comprises initiating a programming session in a clinical setting.

13. The method of claim 1, further comprising:
interrogating the medical device to extract information stored by the medical device; and
sending the information extracted from the medical device to the clinical information system; and
storing the information within the clinical information system.

14. The method of claim 1, further comprising:
receiving input from the programming operator via the interface identifying administrative data; and
sending the administrative data to the clinical information system.

15. The method of claim 1, wherein the clinical information system comprises one of a healthcare information system, an electronic medical records system, a practice management system, a cardiovascular information system, a clinical laboratory information system, radiology information system, and a picture archiving and communication system.

16. The method of claim 1, wherein the medical device comprises one of an implantable pacemaker, an implantable cardioverter/defibrillator (ICD), an implantable pacemaker/cardioverter/defibrillator (PCD), a neurostimulation device, and a drug delivery device.

17. A system comprising:
a programmable medical device that delivers a therapy to a patient;
a clinical information system that stores patient medical information;
a medical device programmer that accesses patient medical information of the clinical information system and provides an interface by which a programming operator interacts with the medical device programmer to identify a programming parameter value based on the patient medical information

18. The system of claim 17, wherein the medical device programmer directly accesses the patient medical information of the clinical information system.

19. The system of claim 17, further comprising a gateway device the couples the medical device programmer and the clinical information system, wherein the medical device programmer accesses the patient medical information of the clinical information system via the gateway device.

20. The system of claim 19, wherein the gateway device filters the patient medical information to obtain a subset of the patient medical information from the clinical information system.

21. The system of claim 19, wherein the gateway device computes a programming parameter value based on the patient medical information.

22. The system of claim 17, wherein the medical device programmer filters the patient medical information to obtain a subset of the patient medical information of the clinical information system.

23. The system of claim 17, wherein the medical device programmer presents the patient medical information to the programming operator.

24. The system of claim 17, wherein the medical device programmer automatically computes a programming parameter value based on the patient medical information and suggests the programming parameter value to the programming operator.

25. The system of claim 17, wherein the medical device programmer initiates a programming session with the medical device to reprogram the medical device.

26. The system of claim 25, wherein the programming session comprises a remote programming session.

27. The system of claim 26, further comprising a remote programmer, wherein the medical device programmer sends instructions to the remote programmer via a network to initiate the remote communication session.

28. The system of claim 17, wherein the medical device programmer interrogates the medical device to extract information stored by the medical device and relays the information extracted from the medical device to the clinical information system or storage.

29. The system of claim 17, wherein the medical device programmer receives input from the programming operator via the interface identifying administrative data and sends the administrative data to the clinical information system.

30. The system of claim 29, wherein the clinical information system performs a management action in accordance with the administrative data.

31. The system of claim 30, wherein the clinical information system automatically generates at least one of a bill and a subsequent appointment.

32. The system of claim 17, wherein the clinical information system comprises one of a healthcare information system, an electronic medical records system, a practice management system, a cardiovascular information system, a clinical laboratory information system, radiology information system, and a picture archiving and communication system.

33. The system of claim 17, wherein the medical device comprises one of an implantable pacemaker, an implantable cardioverter/defibrillator (ICD), an implantable pacemaker/cardioverter/defibrillator (PCD), a neurostimulation device, and a drug delivery device.

34. A programming device comprising:
a medical information interface by which the programming device accesses patient medical information of a clinical information system; and
a user interface by which a programming operator interacts with the programming device to identify a programming parameter value based on the patient medical information.

35. The device of claim 34, wherein the medical information interface accesses patient medical information of the clinical information system via a gateway device coupling the medical device programmer and the clinical information system.

36. The device of claim 35, wherein the programming device filters the patient medical information to obtain a subset of the patient medical information from the clinical information system.

37. The device of claim 34, wherein the user interface comprises a display monitor and the programming device displays the patient medical information to the programming operator via the display monitor.

38. The device of claim 34, further comprising a parameter computing unit that computes a programming parameter value based on the patient medical information, wherein the programming device displays the computed programming parameter value to the programming operator via the user interface.

39. The device of claim 34, further comprising a wireless telemetry module and an antenna, wherein the programming device initiates a programming session with the medical device to reprogram the programming parameters of the medical device.

40. The device of claim 34, further comprising a communication unit, wherein the programming device relays instructions via the communication unit and a network to a remote medical device programmer that initiates the programming session

41. The device of claim 34, wherein the medical device comprises one of an implantable pacemaker, an implantable cardioverter/defibrillator (ICD), an implantable pacemaker/cardioverter/defibrillator (PCD), a neurostimulation device, and a drug delivery device.

42. A computer-readable medium comprising instructions to cause a processor to:
access patient medical information of a clinical information system with a medical device programmer;
provide an interface by which a programming operator interacts with the medical device programmer to identify a programming parameter value based on the patient medical information; and
program a medical device with the medical device programmer in accordance with the programming parameter value.

43. The computer-readable medium of claim 42, wherein the instructions cause the processor to directly access the patient medical information of the clinical information system.

44. The computer-readable medium of claim 42, wherein the instructions cause the processor to access the patient medical information of the clinical information system via a gateway device that couples the clinical information system and the medical device programmer.

45. The computer-readable medium of claim 42, wherein the instructions cause the processor to filter the patient medical information to obtain a subset of the patient medical information from the clinical information system.

46. The computer-readable medium of claim 42, wherein the instructions cause the processor to access the patient medical information of a plurality of clinical information systems.

47. The computer-readable medium of claim 42, wherein the instructions cause the processor to present the patient medical information to the programming operator via the medical device programmer.

48. The computer-readable medium of claim 42, wherein the instructions cause the processor to:
automatically compute a programming parameter value based on the patient medical information; and
display the computed programming parameter value to the programming operator via the medical device programmer.

49. The computer-readable medium of claim 42, wherein the instructions cause the processor to:
interrogate the medical device to extract information stored by the medical device; and
send the information extracted from the medical device to the clinical information system; and
store the information within the clinical information system.

50. The computer-readable medium of claim 42, wherein the instructions cause the processor to:
receive input from the programming operator via the interface identifying administrative data; and
send the administrative data to the clinical information system.

51. The computer-readable medium of claim 42, wherein the clinical information system comprises one of a healthcare information system, an electronic medical records system, a practice management system, a cardiovascular information system, a clinical laboratory information system, radiology information system, and a picture archiving and communication system.

52. The computer-readable medium of claim 42, wherein the medical device comprises one of an implantable pacemaker, an implantable cardioverter/defibrillator (ICD), an implantable pacemaker/cardioverter/defibrillator (PCD), a neurostimulation device, and a drug delivery device.
